(19) United States
(12) Patent Application Publication
(10) Pub. No.: US 2026/0054747 A1
(43) Pub. Date: Feb. 26, 2026

(54) SYSTEMS AND METHODS FOR IDENTIFICATION OF OBSCURED LAW ENFORCEMENT VEHICLES

(71) Applicant: Torc Robotics, Inc., Blacksburg, VA (US)

(72) Inventors: Akshay Pai Raikar, Austin, TX (US); William Gray Davis, Austin, TX (US); Mihir Deshingkar, Austin, TX (US); Justin Francis Yurkanin, Austin, TX (US); Joseph R. Fox-Rabinovitz, Austin, TX (US)

(21) Appl. No.: 18/810,204

(22) Filed: Aug. 20, 2024

(51) Int. Cl. B60W 60/00; B60W 30/18; B60W 50/00

(52) U.S. Cl. CPC B60W 60/0015; B60W 30/18163; B60W 50/0097; B60W 2420/403; B60W 2420/408; B60W 2556/10

(57) ABSTRACT

Systems and method for detecting a law enforcement vehicle. The system includes a sensor disposed on the autonomous vehicle. The sensor is configured to capture sensor data representing a road and an environment in which the autonomous vehicle is operating. The sensor data includes operational data and ancillary data. The system further includes an autonomy computing system comprising a processor and a memory. The autonomy computing system is configured to process the sensor data to segment the operational data and the ancillary data, operate the autonomous vehicle based on the operational data, identify an object in the ancillary data, correlate the object to a law enforcement vehicle, and modify operation of the autonomous vehicle for an enforcement zone associated with the law enforcement vehicle.

### TECHNICAL FIELD

The field of the disclosure relates generally to autonomous vehicle technologies and, more specifically, enhancing the environmental perception capabilities of autonomous vehicles by detecting and analyzing objects and conditions outside the boundaries of the road that may impact the vehicles operation.

### BACKGROUND OF THE INVENTION

Autonomous vehicles utilize various sensors to detect and analyze road conditions in order to safely operate. These systems continuously scan the surroundings of the autonomous vehicle to detect and interpret road conditions, ensuring safe operation of the vehicle. Conventional autonomous vehicle systems capture sensor data and filter it to focus on the portions most relevant for identifying obstacles and perceive the environment without human input. This allows the vehicle to efficiently process data to evaluate road conditions.

The conventional approach allows for the optimization of data processing resources on the autonomous vehicle to ensure the primary operation of the autonomous vehicle is navigating based on road conditions and immediate obstacles. However, this limits the autonomous vehicle's ability to detect conditions outside the boundaries of the road that impact the autonomous operation of the vehicle. For instance, law enforcement vehicles frequently obscure themselves from view outside the road while policing an area. Conventional autonomous vehicles focus only on the road and would fail to detect the hidden law enforcement vehicles. Accordingly, conventional autonomous vehicles would fail to detect these hidden vehicles by excluding data from outside the road for processing.

Additionally, the limitation of the conventional system causes problems because human drivers in the presence of law enforcement behave more erratically in their driving patterns. For example, human drivers may abruptly reduce speed change lanes, or otherwise alter their normal driving patterns near law enforcement activity. The erratic behavior poses an additional challenge for autonomous vehicles, which, by design, adhere strictly to programmed rules and norms of road conduct. This leaves autonomous vehicles vulnerable to otherwise avoidable accidents and disruptions in such situations.

The conventional focus of autonomous vehicle sensor systems on the roadway alone presents a limitation in the operational awareness of the autonomous vehicle. Accordingly, there exists a need for improved systems and methods that expand the situational awareness of autonomous vehicles beyond the boundaries of the road.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system for detecting a law enforcement vehicle from an autonomous vehicle is provided. The system also includes a sensor disposed on the autonomous vehicle, the sensor configured to capture sensor data representing a road and an environment in which the autonomous vehicle is operating, the sensor data includes operational data and ancillary data. The system also includes an autonomy computing system including a processor and a memory storing computer executable instructions. The processor, upon executing the computer executable instructions, is configured to: process the sensor data to segment the operational data and the ancillary data, operate the autonomous vehicle based on the operational data, identify an object in the ancillary data, correlate the object to a law enforcement vehicle, and modify operation of the autonomous vehicle for an enforcement zone associated with the law enforcement vehicle.

In another aspect, an autonomous vehicle system is provided. The autonomous vehicle includes a sensor disposed on the autonomous vehicle, the sensor configured to generate sensor data representing a road and an environment in which the autonomous vehicle is operating, the sensor data includes operational data and ancillary data. The autonomous vehicle also includes an autonomy computing system including a processor and a memory storing computer executable instructions. The processor, upon executing the computer executable instructions, configured to: process the sensor data to segment the operational data and the ancillary data, operate the autonomous vehicle based on the operational data, identify an object in the ancillary data, correlate the object to a law enforcement vehicle, and modify operation of the autonomous vehicle for an enforcement zone associated with the law enforcement vehicle.

In yet another aspect a computer-implemented method for detecting a law enforcement vehicle form an autonomous vehicle is provided. The includes capturing sensor data using a sensor disposed on the autonomous vehicle, the sensor data representing a road and an environment in which the autonomous vehicle is operating, the sensor data includes operational data and ancillary data. The method further includes processing sensor data on an autonomy computing system to segment the operational data and the ancillary data, operating the autonomous vehicle based on the operational data, identifying an object in the ancillary data, correlating the object to a law enforcement vehicle, and modifying operation of the autonomous vehicle for an enforcement zone associated with the law enforcement vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is an illustration depicting the detection of the law enforcement vehicle;

FIG. 4 is an illustration depicting an alternate view of the detection of the law enforcement vehicle;

FIG. 5 is a flow chart of a method of detecting the law enforcement vehicle; and

FIG. 6 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Systems and methods for detecting a law enforcement vehicle using ancillary sensor data are provided. Autonomous vehicles include a plurality of sensors disposed on the autonomous vehicle to capture sensor data to facilitate autonomous operation. The sensor includes at least one of a camera or a LiDAR sensor. In various embodiments, the sensor captures data representing a road and an environment in which the autonomous vehicle is operating. For example, the road data includes traffic conditions and information about other vehicles on the road. The environmental data includes weather data and additional information about the environment surrounding the road.

In various embodiments, the sensor captures excess data beyond what is required to operate the autonomous vehicle. To reduce the processing required to facilitate the autonomous operation, the sensor data is segmented into operational data and ancillary data. In various embodiments, the sensor data is segmented by the autonomy computing system. The operational sensor data is processed by the autonomy computing system to operate the autonomous vehicle. The ancillary data is excluded from processing by the autonomy computing system for operating the autonomous vehicle under nominal operating conditions.

In various embodiments, the ancillary data is processed by the autonomy computing system to detect an object beyond the scope of the operational data. For example, the object is detected on the side of the road where there is limited to no impact on the operation of the autonomous vehicle. In various embodiments, the detected object is correlated to a law enforcement vehicle.

Upon the correlation of the object to a law enforcement vehicle, the autonomy computing system modifies the operation of the autonomous vehicle in an enforcement zone associated with the law enforcement vehicle. In various embodiments, the enforcement zone is associated with a region where the presence of the law enforcement vehicle increases unpredictability of drivers surrounding the autonomous vehicle. For example, vehicles in an enforcement zone may suddenly reduce speed, change lanes, or execute other erratic maneuvers that would otherwise be uncharacteristic in the enforcement zone but for the presence of the law enforcement vehicle. In some embodiments, the autonomous vehicle decreases safety tolerances for operating the vehicle to provide increased response time to any erratic behavior from other vehicles in the enforcement zone. In various embodiments, the autonomous vehicle initiates a lane change operation in the enforcement zone. Upon exiting the enforcement zone, the autonomy computing system terminates the modified operation of the autonomous vehicle.

In various embodiments, the autonomy computing system generates an indication related to the law enforcement vehicle and transmits the indication to a mission control. The indication is recorded to a law enforcement activity database. The law enforcement activity database includes prior indications of a law enforcement vehicle and enforcement zones detected by a fleet of autonomous vehicles. In various embodiments, the data from the law enforcement activity database is used by the autonomy computing system to predict an additional enforcement zone based on the previous law enforcement zone data from the law enforcement activity database.

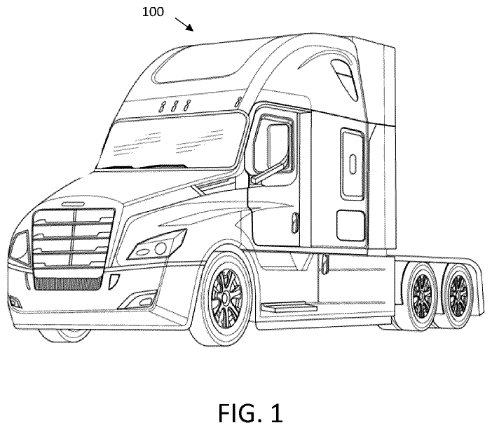

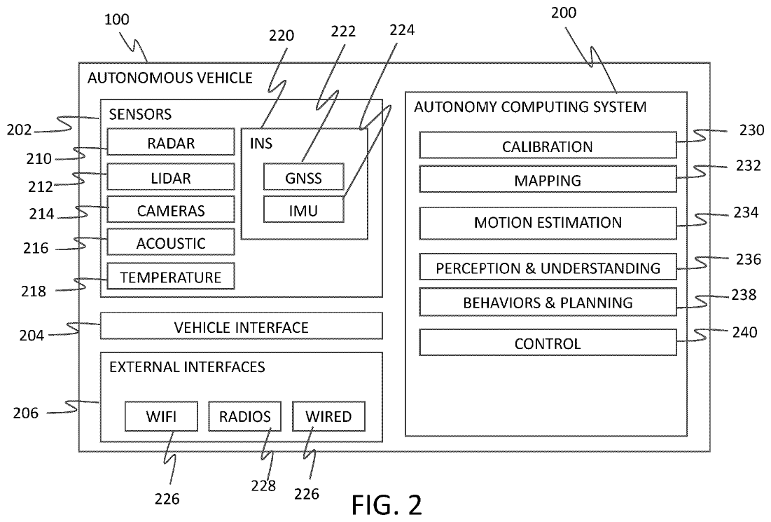

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

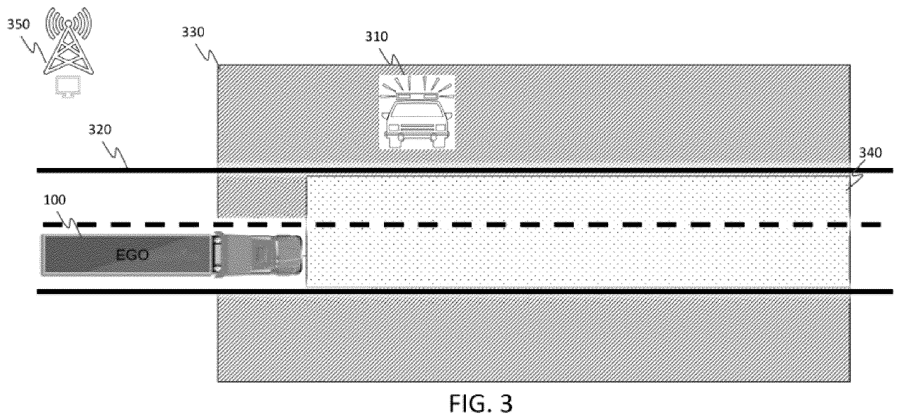

FIG. 3 is an illustration depicting the autonomous detection of the law enforcement vehicle 310. As autonomous vehicle 100 travels down a road 320, the sensor disposed on the autonomous vehicle 100 captures sensor data in a first region 330. The size and scope of the first region 330 of captured sensor data corresponds to the operational characteristics of the sensor including sensor range, sensor aperture, and the location of the sensor disposed on the autonomous vehicle 100. In various embodiments, the autonomy computing system 200 processes the sensor data to segment the sensor data into operational data and ancillary data.

The autonomy computing system 200 operates the autonomous vehicle 100 based on the operational data. In various embodiments, the operational data corresponds to a second region 340 of the captured sensor data. The second region 340 is a subset of the first region 330 of sensor data captured by the sensor. For example, the second region 340 includes the sensor data of the road 320 where additional vehicles on the road and traffic conditions occur that are utilized by the autonomy computing system 200 to operate the autonomous vehicle 100. In various embodiments, the autonomy computing system 200 determines the boundaries of the second region 340 based on to the operating status of the autonomous vehicle 100. Operating the autonomous vehicle 100 using a segmented portion of the sensor data reduces the sensor data processed by the autonomy computing system 200 to operate the autonomous vehicle 100.

In various embodiments, the sensor data captured in the first region 330 but outside the second region 340 is segmented as the ancillary data. The autonomy computing system 200 performs object detection on the ancillary data. In various embodiments, the identified objects in the ancillary data are correlated to a law enforcement vehicle 310. Upon correlation of the identified object to the law enforcement vehicle 310, the autonomy computing system 200 modifies the operation of the autonomous vehicle 100 for an enforcement zone associated with the law enforcement vehicle 310.

In various embodiments, other vehicles on the road 320 exhibit erratic behavior in the presence of a law enforcement vehicle 310. Accordingly, the autonomy computing system 200 modifies the operation of the autonomous vehicle 100 upon the detection of the law enforcement vehicle 310 to safely navigate the enforcement zone. In some embodiments, the autonomy computing system 200 initiates a lane change operation in the enforcement zone. The enforcement zone may correspond to the location of the autonomous vehicle 100 upon detection of the law enforcement vehicle 310 and terminate after a predetermined distance. In some embodiments, the enforcement zone terminates upon detection of a return to nominal traffic conditions from the sensor data. Upon departure from the enforcement zone, the autonomy computing system 200 terminates the modified operation of the autonomous vehicle 100.

In some embodiments, the autonomy computing system 200 is connected to a mission control. The mission control 350 is connected to a fleet of autonomous vehicles. The autonomy computing system 200 is configured to generate and transmit an indication relating to the law enforcement vehicle 310 to the mission control 350. The indication is then recorded to a law enforcement activity database. In some embodiments, the autonomous vehicle 100 predicts the location of an additional enforcement zone based on previous law enforcement zone data from the law enforcement activity database.

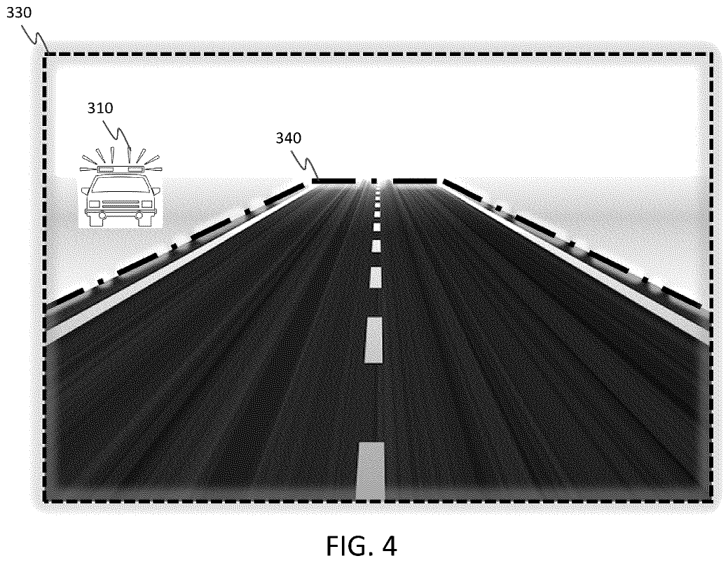

FIG. 4 is an illustration depicting an alternate view of the detection of the law enforcement vehicle 310. As shown in FIG. 4 the second region 340 used for the operational data is a subset of the first region 330 captured by the sensor on the autonomous vehicle 100. Accordingly, operating the autonomous vehicle 100 using the operating data from the second region 340 the autonomy computing system 200 reduces the computational resources required to process the sensor data to operate the autonomous vehicle 100. Additionally, the autonomy computing system 200 leverages the additional data captured by the sensor in the first region 330 to detect the law enforcement vehicle using existing sensors on the autonomous vehicle 100.

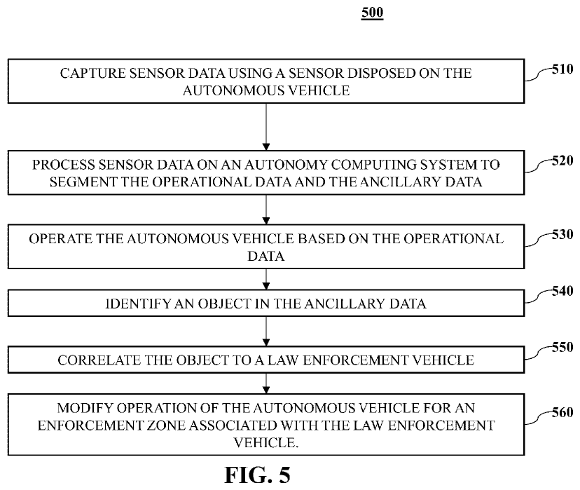

FIG. 5 is a flow chart of a method of detecting the law enforcement vehicle. More specifically, method 500 may be embodied, for example, in a processing system onboard autonomous vehicle 100, such as autonomy computing system 200. In various embodiments, the system captures 510 sensor data using a sensor disposed on an autonomous vehicle 100. The sensor includes a camera and a LiDAR sensor. The sensor captures sensor data representing a road and an environment in which the autonomous vehicle 100 is operating. For example, the sensor data representing the road includes sensor data in the lane of travel of the autonomous vehicle 100 and oncoming lanes including traffic conditions and other vehicles on the road. Additionally, the sensor data representing the environment includes weather data, and data outside of the roadway.

In various embodiments, the method includes processing 520 sensor data sensor data on an autonomy computing system 200 to segment operational data and ancillary data. The autonomy computing system 200 operates 530 the autonomous vehicle 100 based on the operating data. The method also includes identifying 540 an object in the ancillary data. The autonomy computing system 200 correlates 550 identified object to a law enforcement vehicle 310. For example, the identified object may be at least partially obscured or hidden away from the road. The processor identifies the object, and then correlates the identified object to a law enforcement vehicle 310. The autonomy computing system then modifies 560 the operation of the autonomous vehicle 100 for an enforcement zone associated with the law enforcement vehicle 310. Upon departure from the enforcement zone, the autonomy computing system 200 terminates the modified operation of the autonomous vehicle 100. In some embodiments, the autonomy computing system 200 initiates a lane change operation in the enforcement zone. The ancillary data is used to detect 530 a law enforcement vehicle.

In various embodiments, the autonomy computing system 200 is connected to a mission control 350. The autonomy computing system generates and transmits an indication of the enforcement zone to the mission control. The indication is then recorded to a law enforcement activity database.

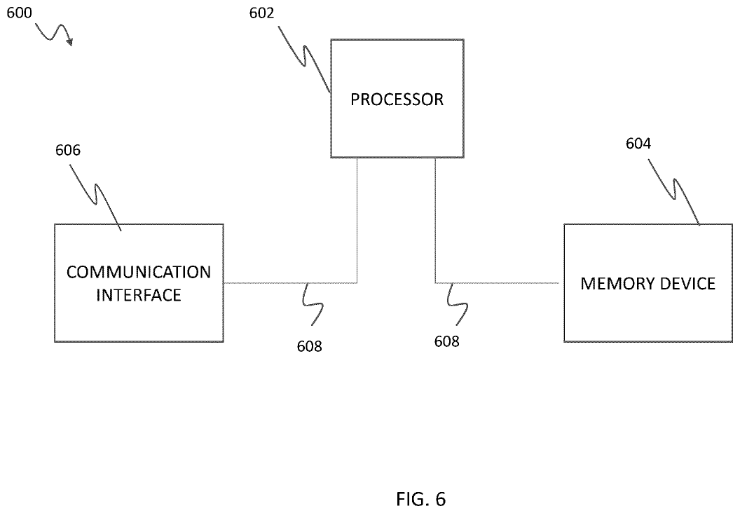

FIG. 6 is a block diagram of an example computing device 600. Computing device 600 includes a processor 602 and a memory device 604. The processor 602 is coupled to the memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 604 includes one or more devices that enable information, such as executable instructions or other data (e.g., sensor data), to be stored and retrieved. Moreover, the memory device 604 includes one or more computer readable media, such as, without limitation, dynamic random access memory (DRAM), static random access memory (SRAM), a solid state disk, or a hard disk. In the example embodiment, the memory device 604 stores, without limitation, application source code, application object code, configuration data, additional input events, application states, assertion statements, validation results, or any other type of data. The computing device 600, in the example embodiment, may also include a communication interface 606 that is coupled to the processor 602 via system bus 608. Moreover, the communication interface 606 is communicatively coupled to data acquisition devices.

In the example embodiment, processor 602 may be programmed by encoding an operation using one or more executable instructions and providing the executable instructions in the memory device 604. In the example embodiment, the processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An autonomy computing system for an autonomous vehicle, the autonomy computing system comprising:
a memory device storing computer executable instructions; and
a processor connected to the memory device, the processor, upon executing the computer executable instructions, configured to:
receive sensor data from a sensor connected to the processor;
process the sensor data to segment into operational data and ancillary data;
operate the autonomous vehicle based on the operational data;
identify an object in the ancillary data;
correlate the object to a law enforcement vehicle; and
modify operation of the autonomous vehicle for an enforcement zone associated with the law enforcement vehicle.

2. The autonomy computing system of claim 1, wherein the processor is further configured to initiate a lane change operation in the enforcement zone.

3. The autonomy computing system of claim 1, wherein the sensor is a camera or a LiDAR sensor.

4. The autonomy computing system of claim 1, wherein the processor is further configured to generate an indication related to the law enforcement vehicle, and transmit the indication to an operating hub.

5. The autonomy computing system of claim 1, wherein the processor is further configured to record the enforcement zone to a law enforcement activity database.

6. The autonomy computing system of claim 1, wherein the processor is further configured to predict an additional enforcement zone based on previous enforcement zone data from a law enforcement activity database.

7. The autonomy computing system of claim 1, wherein the processor is further configured to terminate modified operation upon departure from the enforcement zone.

8. An autonomous vehicle comprising:
a sensor disposed on the autonomous vehicle, the sensor configured to generate sensor data representing a road and an environment in which the autonomous vehicle is operating, the sensor data comprising operational data and ancillary data; and
an autonomy computing system comprising a processor connected to a memory storing computer executable instructions, the processor, upon executing the computer executable instructions, configured to:
process the sensor data to segment the operational data and the ancillary data;
operate the autonomous vehicle based on the operational data;
identify an object in the ancillary data;
correlate the object to a law enforcement vehicle; and
modify operation of the autonomous vehicle for an enforcement zone associated with the law enforcement vehicle.

9. The autonomous vehicle of claim 8, wherein the processor is further configured to initiate a lane change operation in the enforcement zone.

10. The autonomous vehicle of claim 8, wherein the sensor is a camera or a LiDAR sensor.

11. The autonomous vehicle of claim 8, wherein the processor is further configured to generate an indication related to the law enforcement vehicle, and transmit the indication to an operating hub.

12. The autonomous vehicle of claim 8, wherein the processor is further configured to record the enforcement zone to a law enforcement activity database.

13. The autonomous vehicle of claim 8, wherein the processor is further configured to predict an additional enforcement zone based on previous enforcement zone data from a law enforcement activity database.

14. The autonomous vehicle of claim 8, wherein the processor is further configured to terminate modified operation upon departure from the enforcement zone.

15. A computer-implemented method for detecting a law enforcement vehicle from an autonomous vehicle, the method implemented by an autonomy computing system of the autonomous vehicle, the autonomy computing system including a processor and a memory storing executable instructions, the computer-implemented method comprising:
capturing sensor data using a sensor disposed on the autonomous vehicle, the sensor data representing a road and an environment in which the autonomous vehicle is operating, the sensor data comprising operational data and ancillary data;
processing sensor data on the autonomy computing system to segment the operational data and the ancillary data;
operating the autonomous vehicle based on the operational data;
identifying an object in the ancillary data;
correlating the object to the law enforcement vehicle; and
modifying operation of the autonomous vehicle for an enforcement zone associated with the law enforcement vehicle.

16. The computer implemented method of claim 15, wherein the processor is further configured to initiate a lane change operation in the enforcement zone.

17. The computer implemented method of claim 15, wherein the processor is further configured to generate an indication related to the law enforcement vehicle, and transmit the indication to an operating hub.

18. The computer implemented method of claim 15, wherein the processor is further configured to record the enforcement zone to a law enforcement activity database.

19. The computer implemented method of claim 15, wherein the processor is further configured to predict an additional enforcement zone based on previous enforcement zone data from a law enforcement activity database.

20. The computer implemented method of claim 15, wherein the processor is further configured to terminate modified operation upon departure from the enforcement zone.
